(19) United States
(12) Patent Application Publication
(10) Pub. No.: US 2015/0189916 A1
(43) Pub. Date: Jul. 9, 2015

(54) ELECTRONIC SMOKING DEVICE

(71) Applicant: Changming Wu, (US)

(72) Inventor: Changming Wu, Suzhou City (CN)

(73) Assignees: Ahmad Thaer, Commerce, CA (US); Changming Wu, Suzhou City, AnHui Province (CN)

(21) Appl. No.: 13/884,897

(22) PCT Filed: Sep. 29, 2012
(86) PCT No.: PCT/CN2012/082506

§ 371 Date: May 10, 2013

(51) Int. Cl. A24F 47/00; H02J 7/00; H05B 1/02

(52) U.S. Cl. CPC A24F 47/008; H05B 1/023; H02J 7/007

(57) ABSTRACT

This invention discloses an electronic smoking device. The device comprises a shell containing a tobacco container. A heating circuit is configured to heat the tobacco container. At least one energy storage battery placed in the shell and a charging circuit configured to charge the energy storage battery, characterized in that, the electronic smoking device further comprises a general interface set on the shell and a voltage regulation circuit connected between the charging circuit and the energy storage battery. The charging circuit connected to the general interface. By implementing the invention, it can achieve both charging the device with normal voltage and outputting higher baking voltage. The device also can achieve both charging and baking simultaneously, and regulate the output power of baking.

### FIELD OF THE INVENTION

The present invention relates to the electronic smoking device, and more particularly relates to an electronic smoking device that can heat the tobacco for smoking while charging.

### BACKGROUND OF THE UTILITY MODEL

At present, in the field of the electronic smoking device, there are mainly two kinds of product on the market. One is disposable product; another is rechargeable product that is in thread connection with an electronic part. The rechargeable product generally comprises a charging circuit, a charging control circuit, a battery and a baking circuit. All of the circuits are placed in a shell with one interface. However, the disposable product is not chargeable and the rechargeable product cannot be used to smoking while charging. A charging voltage is equal to a voltage of the inner system in the rechargeable product, which cannot effectively provides a better baking power and affects the effect of taste.

### SUMMARY OF THE INVENTION

Aiming at the drawbacks in the prior art, an electronic smoking device that can heat the tobacco while charging is provided in this invention.

According to an aspect, a proposed electronic smoking device includes a shell containing a tobacco container, a heating circuit configured to heat the tobacco container, at least one energy storage battery placed in the shell and a charging circuit configured to charge the energy storage battery, characterized in that, the electronic smoking device further comprises a general interface set on the shell and a voltage regulation circuit connected between the charging circuit and the energy storage battery, the charging circuit connected to the general interface.

Preferably, the general interface is located on the top or bottom of the shell.

Preferably, the general interface is located on the side of the shell.

Preferably, the general interface comprises a USB interface.

Preferably, the electronic smoking device further comprises a heating control circuit, an electronic switch and a temperature sampling circuit configured to feed back a detected temperature signal. The temperature sampling circuit converts the detected temperature signal of the heating circuit to an electric signal, the electric signal is transmitted to the heating control circuit and then controlling an output power of the heating circuit through the electronic switch.

Preferably, a voltage regulating range of the voltage regulation circuit is between 4V and 24V.

Preferably, the temperature sampling circuit comprises a temperature sensor configured to feed back the detected temperature signal from the heating part or the part adjacent to the heating part or service environment of the smoking device.

Preferably, the voltage regulation circuit comprises a boost chip of which the model is CP2121.

Preferably, a charging protective circuit is located between the voltage regulation circuit and the energy storage battery.

When implementing an electronic smoking device of this invention, following advantageous effects achieve:

the electronic smoking device is convenient to operate and doesn't need to screw off the electronic part while charging;

the electronic smoking device also supports that the charging voltage is different from the voltage of the system (MCU), which is convenient for charging;

the electronic smoking device can be charged with normal voltage and output higher or lower baking voltage to achieve a better effect of baking; and

the electronic smoking device can feed back temperature signal from the heating part or the part adjacent to the heating part or the service environment of the smoking device to the heating controller to regulate the baking power to achieve a better effect of baking.

### BRIEF DESCRIPTION OF THE DRAWINGS

The present invention can be further illustrated by reading the example with references made to the accompanying drawings, in which: FIG. 1 is a schematic structure diagram of an electronic smoking device in the first embodiment of the present invention;

FIG. 2 is a schematic structure diagram of an electronic smoking device in the second embodiment of the present invention;

FIG. 3 is a schematic structure diagram of an electronic smoking device in the third embodiment of the present invention;

FIG. 4 is a schematic structure diagram of an electronic smoking device in the fourth embodiment of the present invention;

FIG. 5 is a preferred schematic structure diagram of an inner circuit of an electronic smoking device in the present invention;

FIG. 6 is a schematic circuit diagram of a charging part of an electronic smoking device in the preferred embodiment of the present invention; and

FIG. 7 is a schematic circuit diagram of a baking part of an electronic smoking device in the preferred embodiment of the present invention.

### DETAILED DESCRIPTION OF THE PREFERRED EMBODIMENT

An electronic smoking device comprises a shell 10, a heating circuit 26, at least one energy storage battery 24, a charging circuit 21, a general interface 11 and a voltage regulation circuit 22. Further shell 10 contains a tobacco container. The heating circuit 26 is configured to heat the tobacco container. The energy storage battery 24 is placed in the shell 10. The charging circuit 21 is configured to charge the energy storage battery 24. The general interface 11 is set on the shell 10. The voltage regulation circuit 22 is connected between the charging circuit 21 and the energy storage battery 24. The tobacco container is used for containing cut tobacco, cigarette or other substance to be baked. The general interface 11 may be USB interface. The position for placing the general interface 11 is set in accordance with the structure of the outer shell 10 and the distribution of the inner circuit. The general interface 11 may be located on not only the top or bottom of the shell 10, but also on the side of the shell 10. With the general interface 11, the electronic smoking device in this invention does not need to screw off the electric part while charging and can be directly connect to an outer charging device. Moreover, the general interface 11 makes the device of the invention used universally.

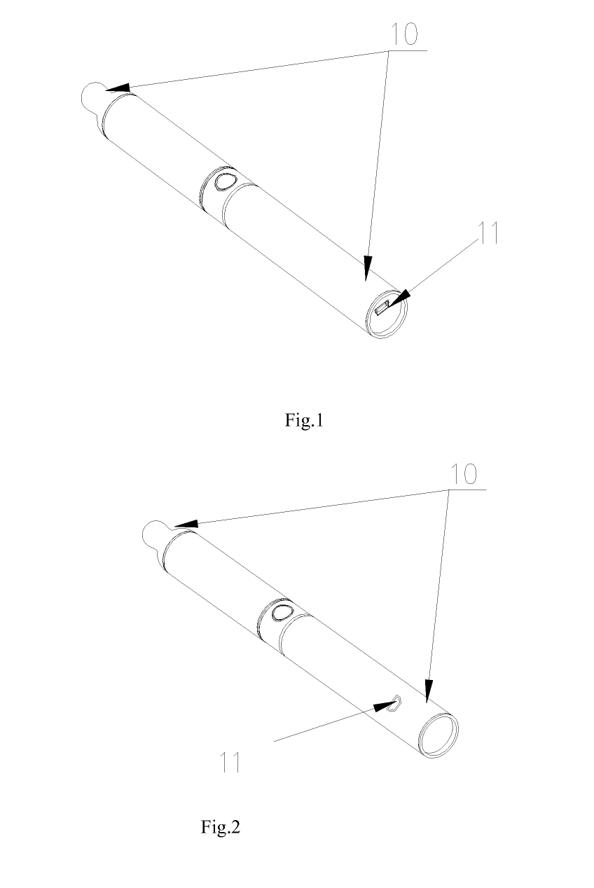

FIG. 1 and FIG. 2 show a cylindrical shell 10. As shown in FIG. 1, the general interface is located on the bottom of the shell 10. As shown in FIG. 2, the general interface 11 is located on the side of the shell 11. The specific location of the general interface is not limited by the preferred location as shown in FIG. 1 and FIG. 2. The general interface 11 can be located on any position on which the device of the invention is convenient to be charged.

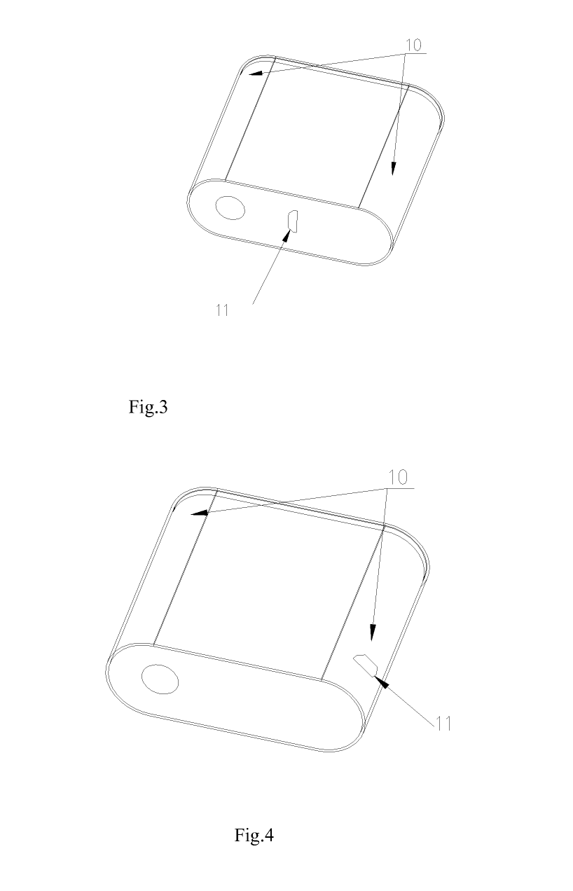

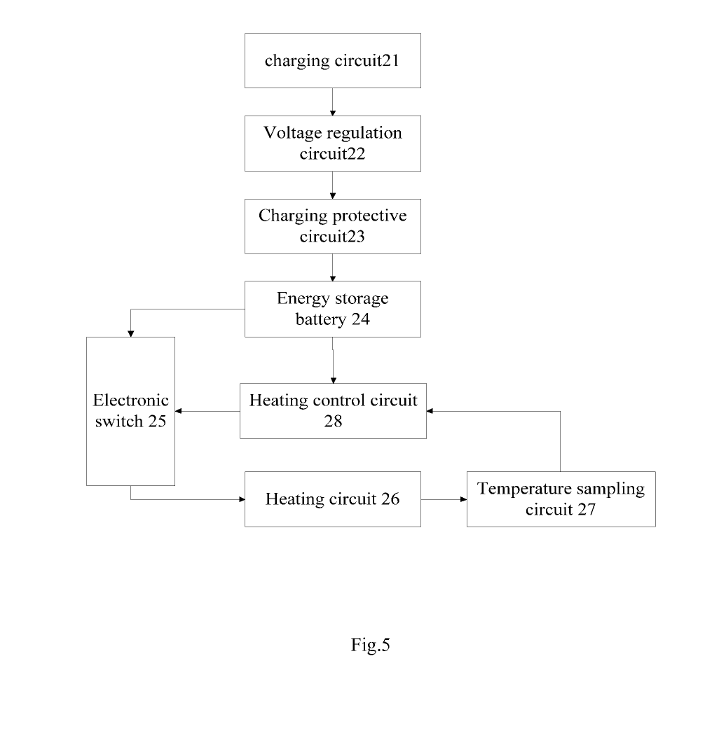

The shape of the shell 10 in this invention is not fully limited. FIG. 3 and FIG. 4 show a shell 10 of a polygon cylinder or other irregular cylinder shape. As shown in FIG. 3, the general interface is located on not only one end face of the shell 10, but also on another end face of the shell 10. As shown in FIG. 4, the general interface 11 is located on the side of the shell 10. The specific location of the general interface is not limited by the preferred location as shown in FIG. 3 and FIG. 4. The general interface 11 can be located on any position on which the device of the invention is convenient to be charged.

As shown in FIG. 5, the electronic smoking device provided by the invention further includes a charging protective circuit 23, an electronic switch 25, a temperature sampling circuit 27 and a heating control circuit 28. The charging circuit 21, the voltage regulation circuit 22, the charging protective circuit 23 and the energy storage battery 24 are in cascade connection in orderly. The energy storage battery 24 supplies electric power for the heating circuit 26 and the heating control circuit 28. The electronic switch 25 can control the heating circuit 26 to be ON or OFF by two means. One is that the heating control circuit 28 applies a signal to the electronic switch 25 to control it to be ON or OFF. Another is that users artificially trigger the electronic switch 25 to control it to be On or OFF.

The inner circuit of the device in the invention includes at least one energy storage battery 24. Generally, the energy storage battery 24 is lithium battery and the capacity of the energy storage battery 24 is between 200 mAH and 2200 mAH. However, it is not limited by the lithium battery, other types of energy storage battery also can be chosen. The charging circuit 21 usually is connected to the outer charging device of which the output voltage is between 5V and 24V. The energy storage battery 24 is charged by a constant voltage to ensure that the battery can be charged sufficiently and avoid overcharging at the same time. The input voltage from the outer charging device is adjusted between 4V and 24V by the voltage regulation circuit 22, according to the needs to achieve the function of the smoking device. The specific regulating voltage is set according to the needs. A low voltage can be converted to a high voltage, on the other hand, a high voltage can be converted to a low voltage according to the needs. The voltage regulation circuit 22 supports that the charging voltage is different from the voltage of system, which is convenient for charging and supplies a higher baking power for the heating circuit 26 to provide a better taste for users. The charging circuit 23 is designed to prevent some instability factor from affecting the effect of the circuit, wherein such instability factor is existed in the circuit. During charging the energy storage battery 24, when the voltage of the battery exceed a maximum threshold, an overcharging control circuit cuts off current and stops charging. During the energy storage battery 24 discharging, when the voltage of the battery reduces to the minimum threshold, an over discharging control circuit cuts off and stops discharging a load. The heating control circuit 28 can control the output power of the heating circuit 26 through the electronic switch 25, according to the temperature of the heating circuit 26. The heating control circuit 28 generally includes a MCU used by the device and its peripheral circuit. The electronic switch 25 includes an electronic switch tube. The electronic switch tube is controlled to be ON or OFF by the heating control circuit 28. The electronic switch tube generally is MOSFE (metal-oxide-semiconductor field-effect transistor) and is directly connected to the energy storage battery 24. The heating circuit 26 is used for heating the tobacco container. The temperature sampling circuit 27 is configured to feed back the detected temperature signal of the heating part or the part adjacent to the heating part or the service environment to the heating control circuit 28. The temperature sampling circuit 27 includes a temperature sensor configured to convert a temperature signal to an electric signal. The temperature sensor includes a thermocouple, thermistor, RTD and IC temperature sensor, wherein the thermocouple and NTC is usually used. The heating control circuit 28, the electronic switch 25, the heating circuit 26 and the temperature sampling circuit 27 form a closed loop to control output power while heating. In short, if the temperature signal detected by the temperature sampling circuit 27 is lower than a preset temperature, the heating circuit 26 is starts up by switching on the electronic switch 25 through heating control circuit 28. In such case, the temperature of a heating unit will increase with the temperature of the temperature sampling circuit 27 increased. If the temperature signal detected by the temperature sampling circuit 27 is higher than the preset temperature, the heating circuit 26 is turned off by switching off the electronic switch 25 through heating control circuit 28. In such case, the temperature of the heating unit will decrease with the sampling temperature of the temperature sampling circuit 27 decreased. Wherein, a system is in such cyclic. ON and OFF is extreme state. Generally, the feedback control system intermittently operates under the PWM state to make the control for the baking power be more accurate and provide a better taste for users.

Moreover, in order to eliminate the difference between the voltage of the energy storage battery 24 and the voltage needed by the MCU in the heating control circuit 28, a DC/DC circuit can be set between the heating control circuit 28 and the energy storage battery 24. The DC/DC circuit is configured to readjust the voltage of the supply power that has been adjusted to the voltage needed by the MCU in the heating control circuit 28.

All of the above, boost or reduction voltage, voltage range provided by the supply power, management for charging and temperature feedback and so on varies according to other different choice, which only relates to the choice about the design elements.

Referring FIG. 5, the electronic smoking device in this invention can achieve functions of: independent charging by starting up the energy storage battery 24 module and the modules above it; independent baking by starting up the energy storage battery 24 module and the module below it and both baking and charging simultaneously by starting up all of the modules.

1) The independent charging process, the device of the invention may include two outer interfaces. One is the general interface 11 configured to make the charging circuit 21 join to the outer charging device; another is heating interface. Both of the two interfaces make the device of the invention be convenient for operating not needing to screw off the electronic part while charging. When the smoking device does not start up, it can achieve independent charging process with the following steps:

the outer charging device is connected to the device of the invention through the general interface 11; in specific, the outer charging device is connected to the charging circuit 21 through the general interface 11; and

the voltage regulation circuit 22 boosts the input voltage (charging voltage), and transmits it to the energy storage battery 24 via the charging protective circuit 23.

2) The independent baking process, when the electric capacity of the energy storage battery 24 is enough to supply electric power for the other electronic elements in the device of the invention, the device can achieve independent baking process with the following step:

users start up the electronic switch 25 to make the energy storage battery 24 supply the needed voltage for the heating circuit 26, without the outer charging device.

During the independent baking process, the temperature sampling circuit 27 feeds back the detected temperature signal of the heating part or the part adjacent to the heating part or the service environment to the heating control circuit 28. The heating control circuit 28 intermittently controls the output power of the heating circuit 26 in the form of PWM by the electronic switch 25.

3) The both charging and baking process, when the energy storage battery 24 is charged by the outer charging device through the charging circuit 21, the voltage regulation circuit 22 and the charging protective circuit 23, users can trigger the electronic switch 25 and start up the heating circuit 26 at the same time to achieve both charging and baking. During the charging and baking process, the temperature sampling feedback process performs normally.

In the preferred embodiment, the heating control circuit 28 generally adopts the way of PWM monocycle feedback control. When the PWM switch's input voltage, inner parameter or external load changes, the control circuit performs a closed loop feedback control. The control circuit adjusts the conductive pulse width of the switch in the main circuit according to differences between controlled signals and reference signals, to make the output voltage or current of the switching power supply be stable. The frequency PWM switch is constant. The controlled signals are consisted of output voltage, input voltage, output current, input current, output induced voltage and peak current of the switch. All of these signals can form a monocycle, bicycle or polycyclic feedback system, which can achieve the aim that make the voltage and the current stabilize and make the power be constant, as well as other attached function such as overcurrent protective, flow equalize and so on.

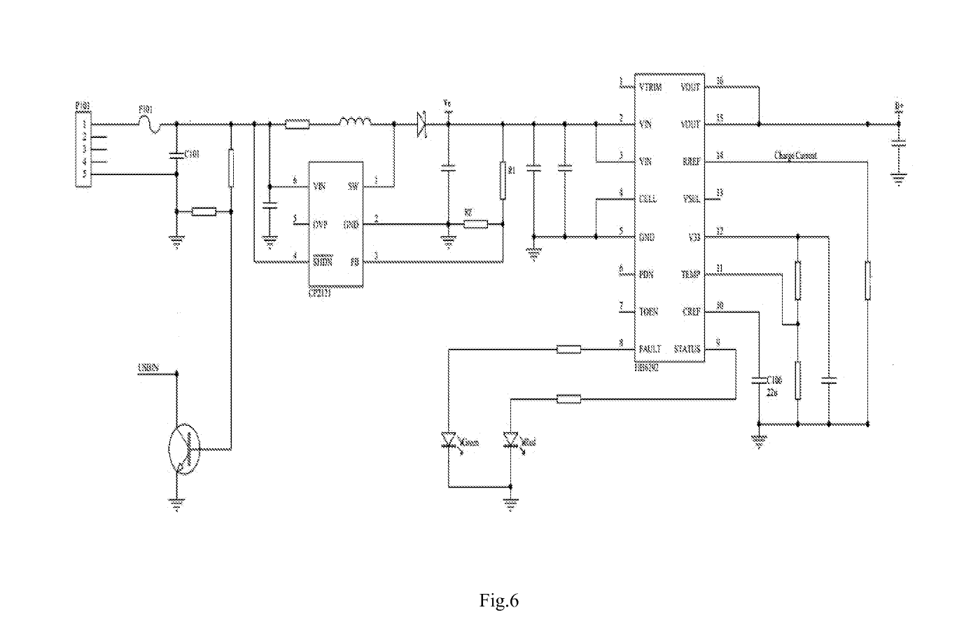

FIG. 6 shows preferred charging circuit 21, voltage regulation circuit 22 and partly charging protective circuit 23 in the device of the invention. In this embodiment, HB6292 chip is a charging chip for battery. USBIN signal detects the charging inserting state. R1 and R2 are regulating resistance configured to regulate the output voltage. It can achieve that the output voltage is boosted by adjusting the resistance to a proper value. The voltage regulation circuit 22 further includes a boost chip CP2121. In this embodiment, in the case of charged by the charging device with capacity of 5V, the inner voltage of the device can be adjusted to at least about 5V by the voltage regulation circuit 22, usually about 8V.

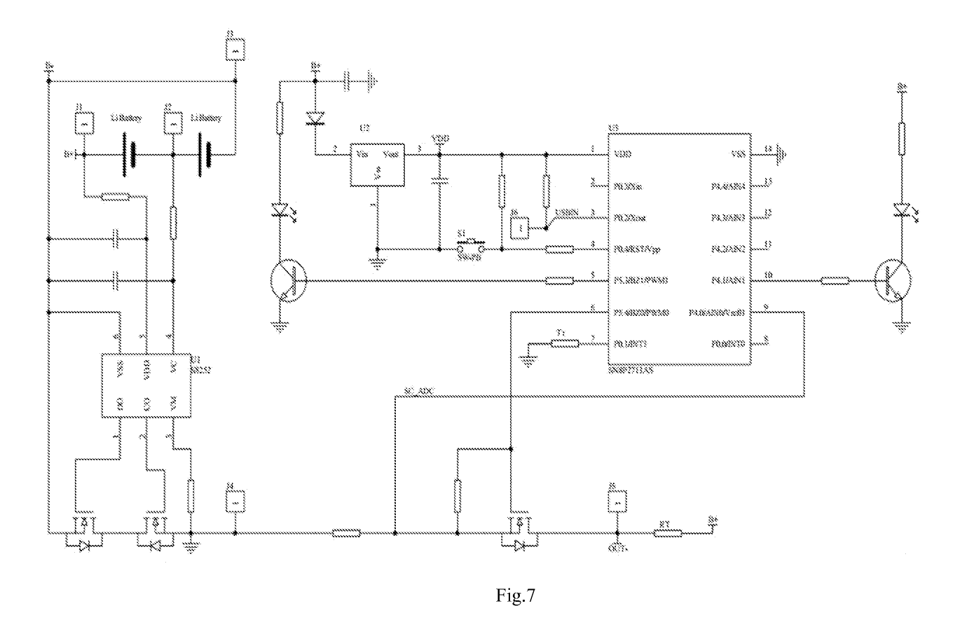

FIG. 7 shows preferred partly charging protective circuit 23, energy storage battery 24, electronic switch 25, heating circuit 26, temperature sampling circuit 27 and heating control circuit 28 in the device of the invention. In this embodiment, the energy storage battery 24 includes two lithium batteries. Reference symbol RT donates the heating unit of the device, which is thermal source for baking in the device. Reference symbol Tr donates a temperature sensor, which is configured to convert the temperature signal to the electric signal and feedback the electric signal to controller. The temperature sensor is NTC. Reference symbol U3_PIN6 is a control signal that donates the heating unit being turned on or off. Reference symbol U1 donates battery protective chip. Reference symbol U3 donates the inner controller of the device.

While the present invention has been described by reference to preferred embodiments, it will be understood by those skilled in the art that various changes may be made and equivalents may be substituted without departing from the scope of the present invention. However, all the changes will be included within the scope of the appended claims.

1. An electronic smoking device, comprising a shell containing a tobacco container, a heating circuit configured to heat the tobacco container, at least one energy storage battery placed in the shell and a charging circuit configured to charge the energy storage battery,
wherein the electronic smoking device further comprises a general interface set on the shell and a voltage regulation circuit connected between the charging circuit and the energy storage battery, the charging circuit connected to the general interface.

2. The electronic smoking device of claim 1, wherein the general interface is set on the top or bottom of the shell.

3. The electronic smoking device of claim 1, wherein the general interface is set on the side of the shell.

4. The electronic smoking device of claim 1, wherein the general interface comprises a USB interface.

5. The electronic smoking device of claim 2, wherein the general interface comprises a USB interface.

6. The electronic smoking device of claim 3, wherein the general interface comprises a USB interface.

7. The electronic smoking device of claim 1, wherein further comprises a heating control circuit, an electronic switch and a temperature sampling circuit; the temperature sampling circuit is configured to feedback a detected temperature signal
the detected temperature signal of the heating circuit is converted into an electric signal by the temperature sampling circuit; and
the electric signal is transmitted to the heating control circuit for controlling an output power of the heating circuit by the electronic switch.

8. The electronic smoking device of claim 1, wherein a voltage regulating range of the voltage regulation circuit is between 4V and 24V.

9. The electronic smoking device of claim 7, wherein the temperature sampling circuit comprises a temperature sensor, which is configured to feedback the detected temperature signal of the heating part or the part adjacent to the heating part or service environment of the smoking device.

10. The electronic smoking device of claim 1, wherein the voltage regulation circuit comprises a boost chip of which the model is CP2121.

11. The electronic smoking device of claim 1, wherein a charging protective circuit is located between the voltage regulation circuit and the energy storage battery.
